(19) United States
(12) Patent Application Publication
(10) Pub. No.: US 2007/0204598 A1
(43) Pub. Date: Sep. 6, 2007

(54) Procedure and device to regenerate an exhaust gas purification system

(75) Inventors: Ralf Wirth, Farmington Hills (DE); Dirk Samuelsen, Ludwigsburg (DE); Stefan Forthmann, Schoental-Ot Berlichingen (DE); Werner Christl, Moeglingen (DE); Carsten Becker, Kernen I.R. (DE); Andreas Fritsch, Waiblingen (DE); Stefan Motz, Moeglingen (DE); Tobias Pfister, Gerlingen (DE); Christian Post, Stuttgart (DE); Andreas Nagel, Kornwestheim (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 11/714,947

(22) Filed: Mar. 6, 2007

(30) Foreign Application Priority Data
Mar. 6, 2006 (DE) 10 2006 010 095.6

(51) Int. Cl. F02M 25/06; F01N 3/02

(52) U.S. Cl. 60/278; 60/311

(57) ABSTRACT

The invention concerns a procedure to control a regeneration of a particle filter in an exhaust gas purification system of a combustion engine, at which combustion air inlet is supplied via a combustion velocity supply duct with a butterfly valve and at which exhaust is recycled in an exhaust duct via an exhaust gas recirculation and/or a low pressure-exhaust gas recirculation, by which exhaust can be supplied to the combustion velocity supply duct. If the gearings of the butterfly valve and the exhaust gas recirculation and/or the low pressure-exhaust gas recirculation are conducted in a pre-defined sequence, it can be reached, that the particle filter is protected from damages because of overheating and at the same time the ease and convenience when driving is not affected.

The invention concerns a procedure to control the regeneration of a particle filter in an exhaust gas purification system of a combustion engine, at which combustion air inlet is supplied via a combustion air inlet duct with a butterfly valve and at which exhaust is recycled in an exhaust duct via an exhaust gas recirculation and/or a low pressure-exhaust gas recirculation, by which exhaust can be supplied to the combustion air inlet duct.

The invention concerns further a device to control a regeneration of a particle filter of an exhaust gas purification system of a combustion engine, at which a butterfly valve is set up in a combustion air inlet duct of the combustion engine and at which an exhaust gas recirculation and/or a low pressure-exhaust gas recirculation is set up in an exhaust duct, which are connected with the combustion air inlet duct.

For some years now, particle filters have been in use to separate soot particles from the exhaust particularly of diesel combustion engines. The soot particles are, in this case, separated on a filter surface, partly also in a filter structure. Particle filters exhibit limited storage ability and need to be regenerated for the restoration of the cleaning effectiveness. With soot particles, this happens by increasing the exhaust temperature to typically 600° C. to 650° C. This can happen by measurements in the fuel-mixture generation of the motor or by post-motor measurements. An exothermal reaction is pushed, which causes a burning up of the soot particles and regenerates the particle filter within a few minutes. An increased oxygen concentration in the exhaust accelerates the burning up and leads to a temperature increase which can concern also only parts of the particle filter, if applicable. A reduced exhaust volume also leads to an increase of the temperature in the particle filter and accelerates the burning up, but can also lead to a local temperature increase. A high material stress of the particle filter can develop, if the exhaust volume is intensively reduced during a running regeneration process or if, additionally, a high oxygen portion in the exhaust forms, like when stopping at a traffic light after a previous fast drive. Also in the boost increased oxygen content in the exhaust performs. The high temperatures, performing in this critical working condition, can damage more cost-effective but thermal less resilient filter materials like sintered metal or cordierite and also catalytic coats of particle filters, which are therefore designed to lower the temperature which is necessary for the regeneration.

According to the status of the technology, the cross section of the air inlet duct is decreased to reduce the oxygen content in the exhaust by means of a butterfly valve in the air inlet duct of the combustion engine. But the butterfly valve is not completely closed in the systems that exist on the market.

EP 1364110 B1 describes a procedure to avoid an overheating of a particle filter, from which a parameter is calculated based on the operation parameter of the combustion engine and/or of the exhaust post-treatment system, that allows a statement regarding it to expect intensity of the reaction in the exhaust post-treatment system. If the parameter exceeds a pre-defined threshold value, measurements to reduce the intensity of the reaction are started. As measurements are the reduction of the quantity of inlet air and/or an additional fuel-delivery control phase and/or an increase of an exhaust gas recirculation rate. It is mentioned, that the butterfly valve can be closed or at least can be closed partly to reduce the inlet air. But an advantageous sequence of the measurements or a simultaneous closing of the butterfly valve and opening of the exhaust gas recirculation are not described.

Based on the unpublished DE 10 2004 048135, it is known to add oxygen to the exhaust to accelerate the burning up for the regeneration of a particle filter and to add nitrogen to slow down the rate of burning. The oxygen and the nitrogen are produced out of the ambient air with the help of an air separation device like a permeable diaphragm for oxygen molecules. With this, the inlet air has to be brought to a gas pressure in a compression level, which is necessary for a sufficient pass through quantity. This requires additional energy consumption, counteracting an economic operation of the combustion engine.

It is the function of the invention to create a procedure, which enables a decrease of the oxygen content in the exhaust to protect a particle filter and does not exhibit thereby noticeable adverse effects for the vehicle driver.

The function is solved in that way, that the gearing of the butterfly valve and the exhaust gas recirculation and/or the low pressure-exhaust gas recirculation are conducted in a pre-defined sequence. With that it can be reached, that the particle filter is protected from damages because of overheating and at the same time the ease and convenience when driving is not affected. By closing the butterfly valve an intake-under pressure of the combustion engine is caused, which is adjusted by opening the exhaust gas recirculation. Particularly by a harmonized sequence of the gearings in the butterfly valve and the exhaust gas recirculation it can be reached, that the gearing happens turning moment neutral and is also not noticeable acoustically. The procedure enabled control of the regeneration process of the particle filter allows the use of cost-effective materials like sintered metal and cordierite for the particle filter.

If gearings of the butterfly valve and the exhaust gas recirculation and/or the low pressure-exhaust gas recirculation are conducted in such a way, that in the first step the exhaust gas recirculation and/or the low pressure-exhaust gas recirculation are opened to reduce the oxygen supply and that in the second step the butterfly valve is closed, it can be reached, that in the time of the transition to a working condition with exhaust rich in oxygen, like the boost, the regeneration process of the particle filter is efficiently slowed down, without the ease and comfort being reduced when driving. Depending on the working condition of the combustion engine, it can be sufficient, if the butterfly valve is not completely closed.

If the gearings of the butterfly valve and the exhaust gas recirculation and/or the low pressure-exhaust gas recirculation are conducted in such a way, that in the first step the butterfly valve is opened to increase the oxygen supply and that in the second step the exhaust gas recirculation and/or low pressure-exhaust gas recirculation is closed up till a pre-defined value, it can be reached, that the regeneration process is continued at the time of the transition to the normal operation and that the turning moment requested by the driver is provided. In that case, the exhaust gas recirculation and/or the low pressure-exhaust gas recirculation is closed up till the value, that corresponds to the normal operation of the combustion engine with the current operation parameters.

One form of the invention, which maintains particularly high the ease and convenience when driving, is such designed, that gearings of the butterfly valve and the exhaust gas recirculation and/or low pressure exhaust gas recirculation are conducted in several procedure cycles. With the step by step method, with which, for example, the butterfly valve is closed by a special quantity and the exhaust gas recirculation opened by a quantity, the change, which is caused in this step of procedure, can be designed imperceptibly for the driver of the vehicle. In the next step the butterfly valve is then closed by a further quantity and the exhaust gas recirculation a bit further opened. This is repeated so long, as the wanted position of the butterfly valve and exhaust gas recirculation is reached.

A smooth transition between different contingencies of the combustion engine can be reached by conducting the gearing of the butterfly valve and the exhaust gas recirculation and/or the low pressure-exhaust gas recirculation turning moment neutral. For this, the adjusting steps of the butterfly valve and the exhaust gas recirculation are harmonized with each other by data records, which are filed in a follow-up control.

In a preferred form it is such designed, that the opening and closing processes of the butterfly valve and the exhaust gas recirculation and/or low pressure-exhaust gas recirculation go along given trajectories.

If an exhaust gas damper is closed additionally to one or several of the aforementioned measurements when opening the low pressure-exhaust gas recirculation, the inlet air and exhaust system of the combustion engine can be separated completely from the environment and can be protected from the entry of oxygen particularly efficiently.

In a follow-up control, which is constructed to perform a procedure according to at least one of the claims, designed to control the gearings of the butterfly valve and the exhaust gas recirculation and/or the low pressure-exhaust gas recirculation in a pre-defined sequence, the particle filters can be protected in a cost-effective and efficient way from damages caused by overheating without additional costly devices being designed. The follow-up control can, if necessary, be realized as a program flow in an existing motor control.

### DRAWINGS

In the following the invention is explained nearer on the basis of the performance examples, described in the figures.

FIG. 1 shows schematic description of a combustion engine with an exhaust gas recirculation,

FIG. 2 shows the combustion engine with a low pressure-exhaust gas recirculation,

FIG. 3 shows a flowchart to control the regeneration of a particle filter.

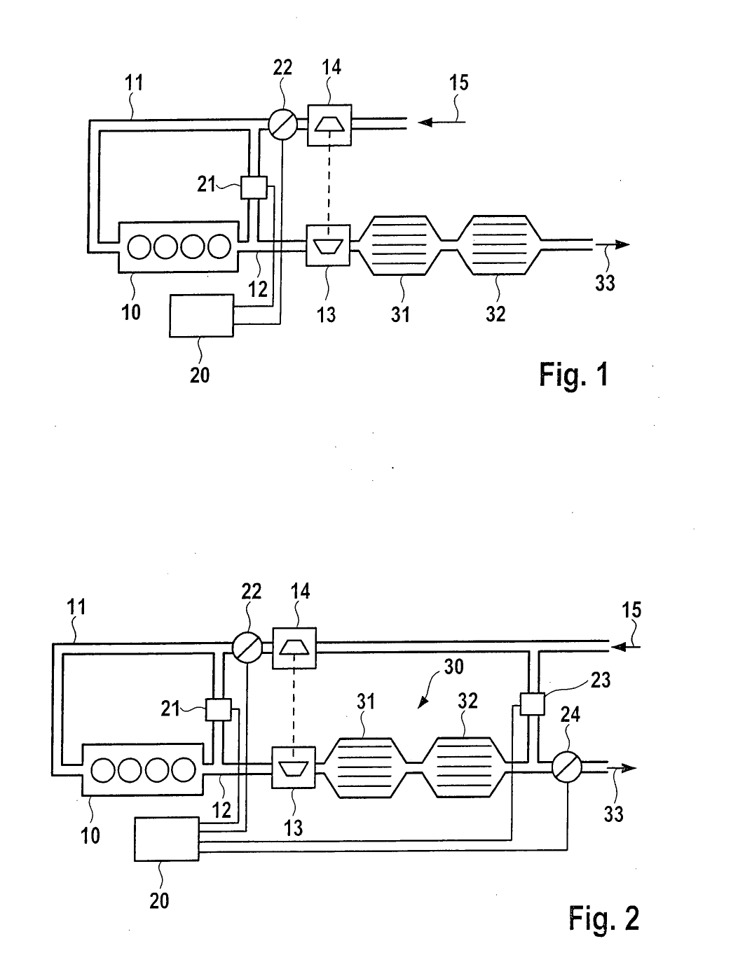

FIG. 1 shows a combustion engine 10 with a combustion velocity supply duct 11 and an exhaust duct 12. In the combustion velocity supply duct 11 a butterfly valve 22 and a compression level 14 are designed, which bring in a supply air stream 15 in regard to the quantity and supercharge pressure up to the value wanted for a momentary operating point of the combustion engine 10. Between the exhaust duct 12 and the combustion velocity supply duct 11 an exhaust gas recirculation 21 is set up. The butterfly valve 22 and the exhaust gas recirculation 21 are controlled by a follow-up control 20. In the exhaust duct 12 of the combustion engine 10 an exhaust gas turbine 13 is set up, which is coupled mechanically with the compression level 14 and which forms an exhaust turbo charger with it. After the exhaust gas turbine 13 in the exhaust duct 12 an exhaust gas purification system 30 is set up designed with an oxidation catalyst 31 and a particle filter 32, which cleans a flue gas stream 33.

According to the invention, the supply of oxygen to control a regeneration of a particle filter 32 can be reduced in that way, that the butterfly valve 22 reduces the cross section of the combustion velocity supply duct 11. With an increasing reduction of the cross section of the combustion velocity supply duct 11 the exhaust gas recirculation 21 is opened, by which less exhaust rich in oxygen gets in the combustion velocity supply duct 11 in comparison to the supply air stream 15. By closing the butterfly valve 22 and opening the exhaust gas recirculation 21 by means of the follow-up control 20 it can succeed in closing the butterfly valve 22 completely without changes in the turning moment or acoustic conspicuousness formed by that. With a completely closed butterfly valve 22 no further oxygen is supplied to the system and the oxygen content of the flue gas stream 33 decreases constantly, as a result of which the burning up of the soot in the particle filter can be slowed down efficiently.

FIG. 2 shows a combustion engine 10, in which an exhaust gas damper 24 is designed in the exhaust duct 12 in addition to the in FIG. 1 described set up. Furthermore a low pressure-exhaust gas recirculation 23 is additionally designed between the exhaust duct 12 and the combustion velocity supply duct 11. The exhaust gas damper 24 and the low pressure-exhaust gas recirculation 23 can be set up in the exhaust duct 12 also in the stream direction before the particle filter 32. The follow-up control 20 is connected to the low pressure-exhaust gas recirculation 23 and the exhaust duct 24 additionally to the in FIG. 1 described set up.

The system can be completely closed from the environment with the butterfly valve 22 and the exhaust gas damper 24. The follow-up control 20 takes care that, for example, an unwanted high exhaust counter-pressure is avoided, which could lead to a brake action or a standstill of the combustion engine 10 by closing the exhaust gas damper 24 simultaneously or by delaying the close of the butterfly valve 22.

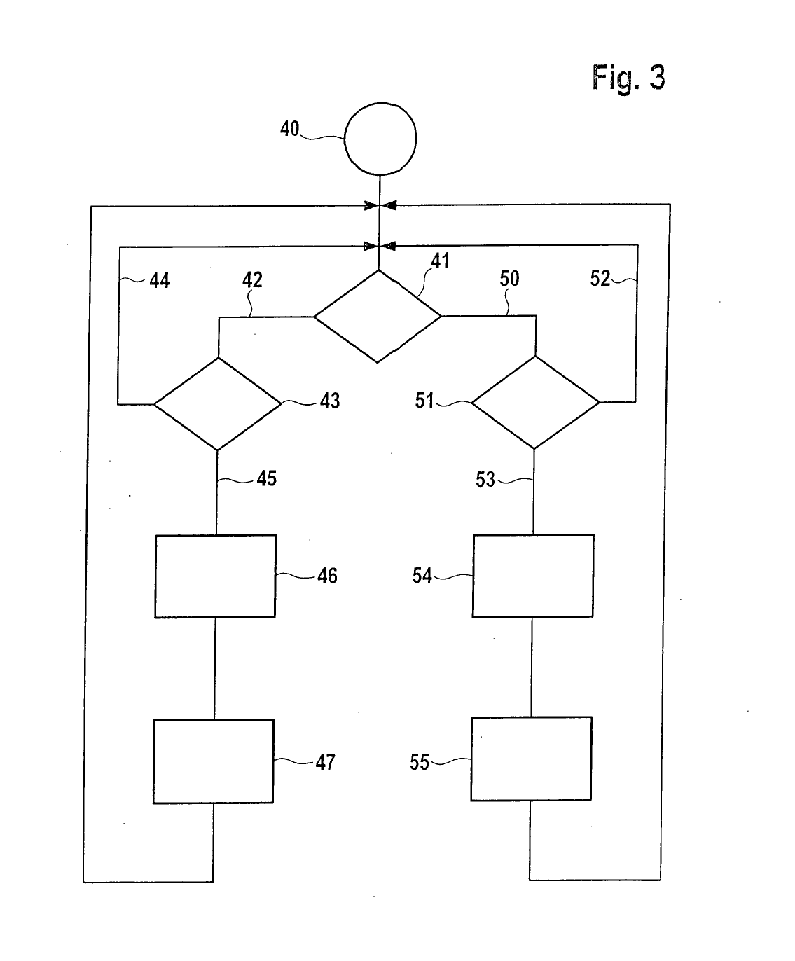

FIG. 3 shows a flowchart of the procedure, according to the invention, to control regeneration for the contingency of boost. For other contingencies, by which the speed of the burning up is controlled by reducing the oxygen supply, the flowchart can be applied accordingly. After a start 40 of the flowchart, a decisive boost 41 happens, in which it is controlled if a boost exists. In the negative case, the process follows a branch no boost 42, which leads to a decisive boost-beginning 43. In the negative case, the decisive boost 41 is reached via a branch no boost-beginning 44. In the positive case, an action open exhaust gas recirculation 46 is reached from the decisive boost-beginning 43 via a branch boost-beginning 45, followed by an action close butterfly valve 47. From the action close butterfly valve 47 the process gets to the decisive boost 41.

If the decisive boost 41 has a positive result, the process gets via a branch boost 50 to a decisive boost-end 51. If the result of the decisive boost-end 51 is negative, the decisive boost 41 is reached via the branch no boost-end 52. If the decisive boost-end 51 has a positive result, the process gets to an action open butterfly valve 54 via a branch boost-end 53 and from there to an action close exhaust gas recirculation 55. From the action close exhaust gas recirculation 55 the process gets back to the decisive boost 41.

This described process has the effect that, from a transition from the normal operation to the boost, this is recognized by the decisive boost-beginning 43 and that at first the action open the exhaust gas recirculation 46 happens and after that the action close butterfly valve 47. Here both actions 46, 47 can happen gradated in several runs of the flowchart, so that a transition, not noticed by the vehicle driver, happens. With this procedure it is possible to close the butterfly valve completely.

Furthermore, the process has the effect that, from the transition from the boost to the normal operation, the decisive boost-end 51 recognizes it and so at first the action open butterfly valve 54 happens and after the action close exhaust gas recirculation 55. Also in this case both actions 54, 55 can happen gradated in several runs of the flowchart preferably along appropriate trajectories.

1. A method for controlling a regeneration of a particle filtered in an exhaust gas purification system of a combustion engine, the method comprising:
supplying air to a combustion air inlet via a combustion velocity supply duct having a butterfly valve;
recycling exhaust in an exhaust duct via an exhaust gas recirculation and/or a low pressure-exhaust gas recirculation; and
supplying exhaust to the combustion velocity supply duct;
wherein gearings of the butterfly valve and the exhaust gas recirculation and/or the low pressure-exhaust gas recirculation are conducted in a pre-defined sequence.

2. A method according to claim 1, wherein the gearings are conducted such that in a first step the exhaust gas recirculation and/or the low pressure-exhaust gas recirculation are opened and in a second step the butterfly valve is closed to reduce the oxygen supply.

3. A method according to claim 1, wherein the gearings are conducted in such that in a first step the butterfly valve is opened and in a second step the exhaust gas recirculation and/or the low pressure-exhaust gas recirculation is closed up till a pre-defined value to increase the oxygen supply.

4. A method according to claim 1, wherein the gearings are conducted in several procedure cycles.

5. A method according to claim 1, wherein the gearings are conducted without changes to a turning moment.

6. A method according to claim 1, wherein opening and closing of the butterfly valve run along specified trajectories.

7. A method according to claim 1, further comprising closing an exhaust gas damper when opening the low pressure-exhaust gas recirculation.

8. A device that controls a regeneration of a particle filter of an exhaust gas purification system of a combustion engine, at which a butterfly valve is set up in a combustion velocity supply duct of the combustion engine and at which an exhaust gas recirculation and/or a low pressure-exhaust gas recirculation is set up in an exhaust duct of the combustion engine, the device comprising a follow-up control, designed to control gearings of the butterfly valve and the exhaust gas recirculation and/or the low pressure-exhaust gas recirculation in a pre-defined sequence, to supply air to a combustion air inlet via the combustion velocity supply duct, to recycle exhaust in the exhaust duct via an exhaust gas recirculation and/or a low pressure-exhaust gas recirculation and to supply exhaust to the combustion velocity supply duct.
